(19) United States
(12) Patent Application Publication
(10) Pub. No.: US 2009/0127016 A1
(43) Pub. Date: May 21, 2009

(54) Pedestrian air bag system

(75) Inventors: Takeki Hayashi, Aichi-ken (JP); Shigeyuki Suzuki, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/292,285

(22) Filed: Nov. 14, 2008

(30) Foreign Application Priority Data
Nov. 15, 2007 (JP) 2007-297159

(51) Int. Cl. B60R 21/34

(52) U.S. Cl. 180/274

(57) ABSTRACT

A hood panel is arranged in a front end side of a vehicle so as to cover an engine room from above. An air bag system according to the invention includes an air bag which is disposed in a containing part near a front fender which is arranged at an end edge of the hood panel in a lateral direction, so as to cover the substantially entire area in a longitudinal direction of the front fender from above when the air bag has been completely inflated, and an inflator for supplying an inflating gas to the air bag. The air bag has a body part for covering the front fender from the above, and a flow inlet connected to the inflator. The flow inlet is provided in a frontward region of the body part forward from a center in the longitudinal direction in the completely inflated state.

### BACKGROUND OF THE INVENTION

1. Field of the Invention

The present invention relates to a pedestrian air bag system capable of protecting a pedestrian from either of front fenders which are positioned at both right and left edges of a hood panel of a vehicle.

2. Related Art

Conventionally, as a pedestrian air bag system for protecting the pedestrian from a front fender, there has been a structure provided with an air bag which is folded and contained near the front fender, in which the air bag covers the front fender from above over substantially an entire area thereof in a longitudinal direction, when the air bag is spread and inflated with an inflating gas which has flowed into the air bag (Reference should be made to JP-A-2007-8278, for example). In this conventional pedestrian air bag system, both front and back ends of the air bag in an elongated shape extending along the longitudinal direction, in the completely inflated state, so as to cover the front fender from the above over the entire area in the longitudinal direction are respectively connected to inflators, and the inflation of the air bag is substantially simultaneously completed over the substantially entire area in the longitudinal direction.

In the pedestrian air bag system of this type, when the pedestrian bumps against a front end face of a vehicle and falls onto a hood panel, a head of the pedestrian is prevented from interfering with the front fender by the air bag which has been inflated so as to cover the front fender from the above. However, a distance from the head of the pedestrian to an upper face of the front fender varies between a short pedestrian having a small height and a tall pedestrian having a large height, and further, a region of the front fender to be struck by the head is different in the longitudinal direction between the short pedestrian and the tall pedestrian. Specifically, in case of the short pedestrian, because the distance from the head of the pedestrian to the upper face of the front fender is relatively small, the head will strike a region of the front fender positioned forward from a center in the longitudinal direction of the front fender at an earlier time, after the pedestrian has bumped against the front face of the vehicle, as compared with the tall pedestrian. For this reason, in the air bag in an elongated shape having a long size in the longitudinal direction, it is desirable to quickly inflate the frontward region which is forward from the center in the longitudinal direction. Therefore, in the conventional pedestrian air bag system, improvement should be made in respect of quickly inflating the frontward region of the air bag.

### SUMMARY OF THE INVENTION

The invention has been made to solve the above described problem, and it is an object of the invention to provide a pedestrian air bag system in which a frontward region of the air bag can be quickly inflated so that a short-height pedestrian can be reliably protected.

According to the invention, there is provided a pedestrian air bag system comprising:

an air bag which folded and contained in a containing part near a front fender arranged at an end edge in a lateral direction of a hood panel disposed at a front end side of a vehicle to cover above an engine room, and

an inflator which is connected to said air bag for enabling inflating gas to be supplied to the air bag,

said air bag being so constructed as to cover a substantially entire area in a longitudinal direction of said front fender, when the inflating gas has flowed into said air bag,

wherein said air bag includes a body part which is inflated to cover above said front fender, and a flow inlet connected to said inflator for allowing the inflating gas to flow from said inflator to said body part, and that said flow inlet is provided only at a position forward from a center in the longitudinal direction of said body part when the air bag has been completely inflated.

In the pedestrian air bag system according to the invention, the flow inlet for allowing the inflating gas from the inflator to flow into the body part of the air bag is provided only at the position forward from the center in the longitudinal direction of the body part when the air bag has been completely inflated. Therefore, when the inflator is operated, the body part of the air bag is first inflated with the inflating gas which has flowed therein from the frontward region which is forward from the center in the longitudinal direction where the flow inlet is provided. For this reason, in the pedestrian air bag system according to the invention, even though the air bag has an elongated shape which is longer in the longitudinal direction in the completely inflated state, the frontward region of the air back can be more quickly inflated at the initial period of the inflation, as compared with the backward region, and it is possible to prevent the head of the short pedestrian from striking the area of the vehicle near the front fender.

Accordingly, in the pedestrian air bag system according to the invention, the frontward region of the air bag can be quickly inflated, and the short pedestrian can be reliably protected.

In the pedestrian air bag system according to the invention, the inflator is provided only at the one position in the frontward region which is forward from the center in the longitudinal direction of the body part of the air bag in the completely inflated state. Therefore, it is of course possible to decrease the number of components, as compared with the conventional pedestrian air bag system, and production steps and cost can be reduced.

Moreover, in the pedestrian air bag system according to the invention, the body part of the air bag is folded so as to reduce its widths in the longitudinal direction and in the lateral direction from a flat spread state, and at the same time, the body part is folded such that at an initial period of the inflation, folds may be released more quickly in a region positioned forward from the flow inlet than in a region positioned backward from the flow inlet, and contained in the containing part. In this structure, at the initial period of the inflation of the air bag, the region positioned forward from the flow inlet, that is, the frontward region is spread more quickly than the region positioned backward from the flow inlet while releasing the folds, and hence, it is advantageously possible to inflate the frontward region of the air bag more quickly.

Further, in the pedestrian air bag system having the above described structure, it would be preferable that a rectifying cloth for rectifying the inflating gas which has been discharged from the inflator is provided inside the air bag, and that

the rectifying cloth is provided with flow outlets for allowing the inflating gas to flow out toward both ends of the body part, respectively at a position forward from the flow inlet and at a position backward from the flow inlet.

In the pedestrian air bag system having the above described structure, the inflating gas which has been discharged from the inflator is rectified by the rectifying cloth so as to flow from the flow inlet toward the both ends in the longitudinal direction to flow through the body part. Therefore, the body part of the air bag can be spread quickly and widely in the longitudinal direction, and it is possible to inflate the backward region too, while the quick inflation of the frontward region is secured.

Still further, in the pedestrian air bag system having the above described structure, it would be preferable that the body part of the air bag is provided with a partition which is arranged substantially along the longitudinal direction in a frontward region thereof which is positioned forward from the center in the longitudinal direction in the completely inflated state, so that when the air bag has been completely inflated, a distance between upper and lower walls of the body part which are opposed to each other in a vertical direction may be narrowed, and the frontward region may be partitioned in the lateral direction, by connecting the upper and lower walls to each other.

In the pedestrian air bag system having the above described structure, because the frontward region in the completely inflated state has such a shape that it size is smaller in thickness and larger in width in the lateral direction as compared with a case where the partition is not provided, the frontward region of the inflated air bag can cover the front side of the front fender from the above over the wide area in the lateral direction. As the results, the front fender including an upper face of a headlamp which is provided in the surrounding can be covered with the frontward region from the above widely in the lateral direction, when the air bag has been completely inflated, and it is possible to stably receive the head of the short pedestrian by the frontward region which has been completely inflated, even though the head of the short pedestrian is somewhat displaced in the lateral direction.

Still further, in the pedestrian air bag system having the above described structure, it would be preferable that the body part of the air bag is connected to the containing part by means of straps which are provided at three or more positions in the longitudinal direction of the body part in the completely inflated state, wherein

two of the straps which are provided at a front end side are arranged at both sides forward and backward from the flow inlet.

In the pedestrian air bag system having the above described structure, because both the regions forward and backward from the flow inlet are connected to the containing part by means of the straps, it is possible to prevent both the regions forward and backward from the flow inlet from being displaced in the vertical direction and in the lateral direction. Moreover, because the straps are provided at the three positions in the longitudinal direction of the body part in the completely inflated state, it is possible to prevent the body part of the air bag from floating from the front fender in the substantially entire area along the longitudinal direction, when it is spread and inflated. As the results, it is advantageously possible to quickly cover the front fender from the above with the body part of the air bag which has been inflated.

Still further, in the pedestrian air bag system having the above described structure, it would be preferable that each of the straps includes an inner member extending from an inner edge of the body part at a side close to the hood panel in the completely inflated state, and an outer member extending from an outer edge which is opposed to the inner edge in the lateral direction, and both distal ends of the inner member and the outer member are fastened together to the containing part at a position close to the hood panel. In this manner, it is possible to restrain the body part of the air bag from being displaced in the vertical and lateral directions, and to prevent the body part from being twisted in the lateral direction, when it is spread and inflated. As the results, it is advantageously possible to inflate the body part of the air bag so as to stably and quickly cover the front fender from the above.

### BRIEF DESCRIPTION OF THE DRAWINGS

FIG. 1 is a perspective view of a vehicle on which air bag systems for a pedestrian in an embodiment according to the invention are mounted.

FIG. 2 is a plan view of the vehicle on which the air bag systems for a pedestrian in the same embodiment are mounted.

FIG. 3 is a side view of the vehicle on which the air bag systems for a pedestrian in the same embodiment are mounted.

FIG. 4 is a schematic perspective view of the vehicle on which the air bag systems for a pedestrian in the same embodiment are mounted, in a state where a hood panel is opened from the front.

FIGS. 5A and 5B are plan views for explaining operation of a lifting unit which is provided on the vehicle on which the air bag systems for a pedestrian in the same embodiment are mounted.

FIG. 6 is a schematic sectional view of the air bag system in the same embodiment taken along a line VI-VI in FIG. 2.

FIG. 7 is a plan view of an air bag used in the pedestrian air bag system in the same embodiment, in a state where the air bag is inflated as a single body.

FIG. 8 is a sectional view taken along a line VIII-VIII in FIG. 7.

FIG. 9 is a sectional view taken along a line IX-IX in FIG. 7.

FIG. 10 is a plan view of the air bag in FIG. 7 and a rectifying cloth, in a state developed flat.

FIG. 11 is a view for explaining folding steps of the air bag in the pedestrian air bag system in the same embodiment.

FIG. 12 is views for explaining the folding steps of the air bag in the pedestrian air bag system in the same embodiment, in which the steps succeeding to FIG. 11 are shown.

FIG. 13 is a perspective view of the vehicle in a state where the air bags in the air bag systems for a pedestrian in the same embodiment have been completely inflated.

FIG. 14 is a schematic sectional view of the pedestrian air bag system in the same embodiment, in a state where the air bag has been completely inflated, showing a frontward region of the air bag.

FIG. 15 is a schematic sectional view of the pedestrian air bag system in the same embodiment, in a state where the air bag has been completely inflated, showing a backward region of the air bag in which a tether is provided.

### DETAILED DESCRIPTION OF THE PREFERRED EMBODIMENTS

Now, an embodiment according to the invention will be described referring to the drawings. In this specification, a longitudinal direction is based on a direction along a front side and a back side of a vehicle, a vertical direction is based on a direction along an upper side and a lower side of the vehicle, and a lateral direction is based on a direction along a right side and a left side of the vehicle, as seen from the front side of the vehicle.

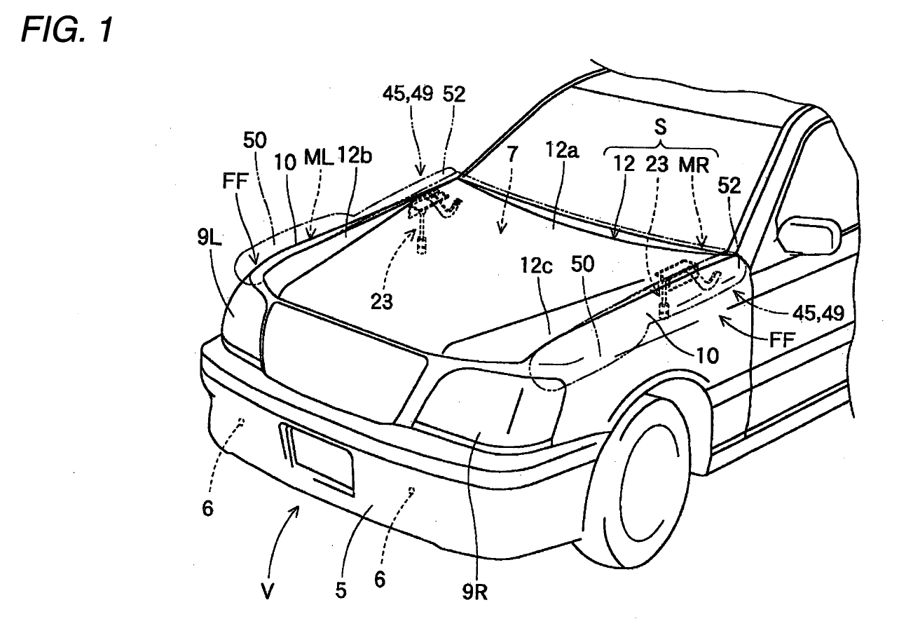

A pedestrian air bag system M in the embodiment (hereinafter referred to simply as “air bag system”) is used in a pedestrian protecting system S, as shown in FIGS. 1 to 4. The pedestrian protecting system S includes, as shown in FIGS. 1 to 4, a hood panel 12 which is arranged at a front end side of a vehicle V, a lifting unit 23 capable of lifting a back end side of the hood panel 12 upward, and one of the air bag systems M which are disposed near front fenders FF at right and left end edges (edges 12b, 12c) of the hood panel 12.

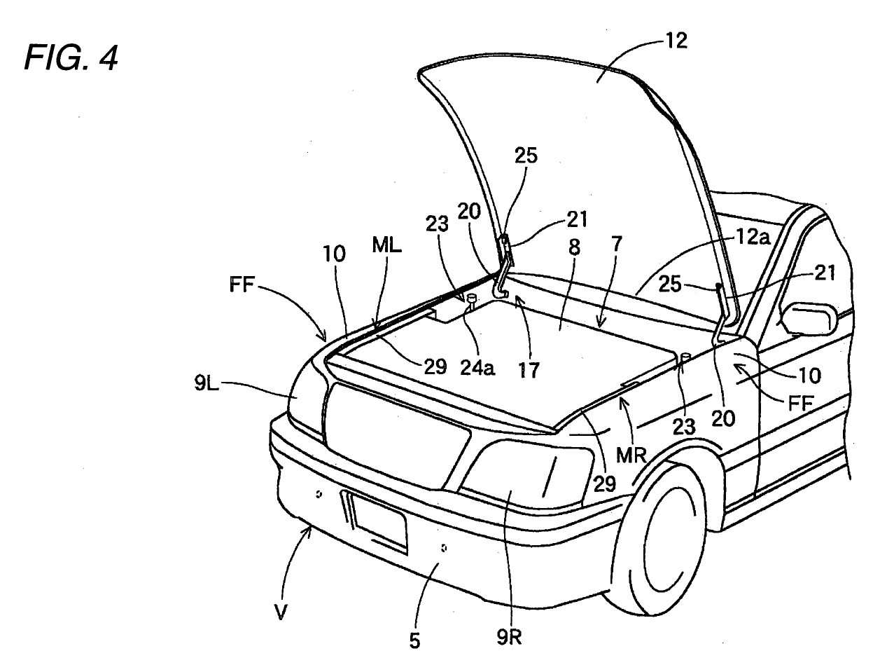

As shown in FIGS. 1 and 4, a front bumper 5 of the vehicle V is provided with sensors 6 which can detect collision of the vehicle against a pedestrian. The pedestrian protecting system S in the embodiment is constructed such that when an actuating circuit (not shown) into which a signal from the sensor 6 is inputted has detected the collision of the vehicle V against the pedestrian based on the signal from the sensor 6, an actuator 24 of the lifting unit 23, which will be described below, and an inflator 38 of the air bag system M, which will be described below, will be actuated.

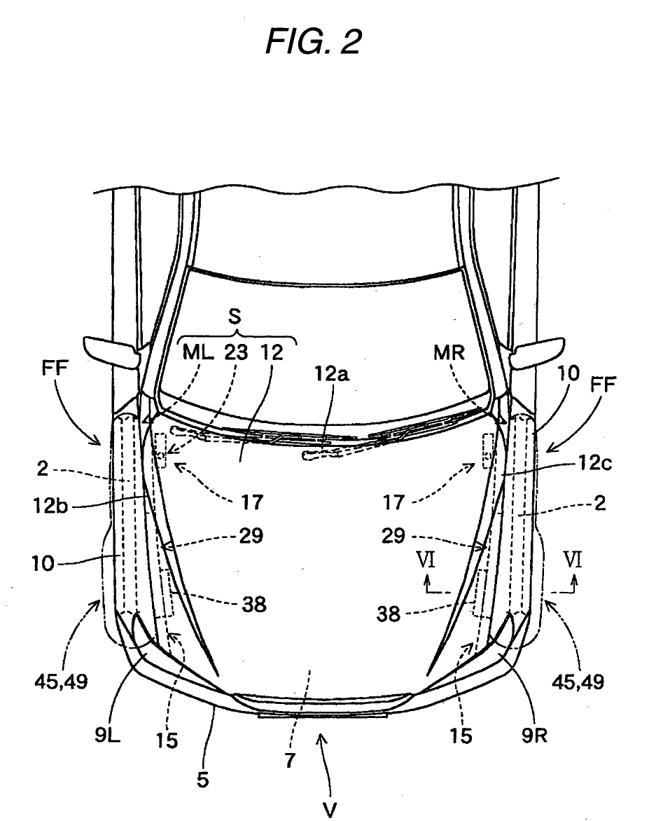

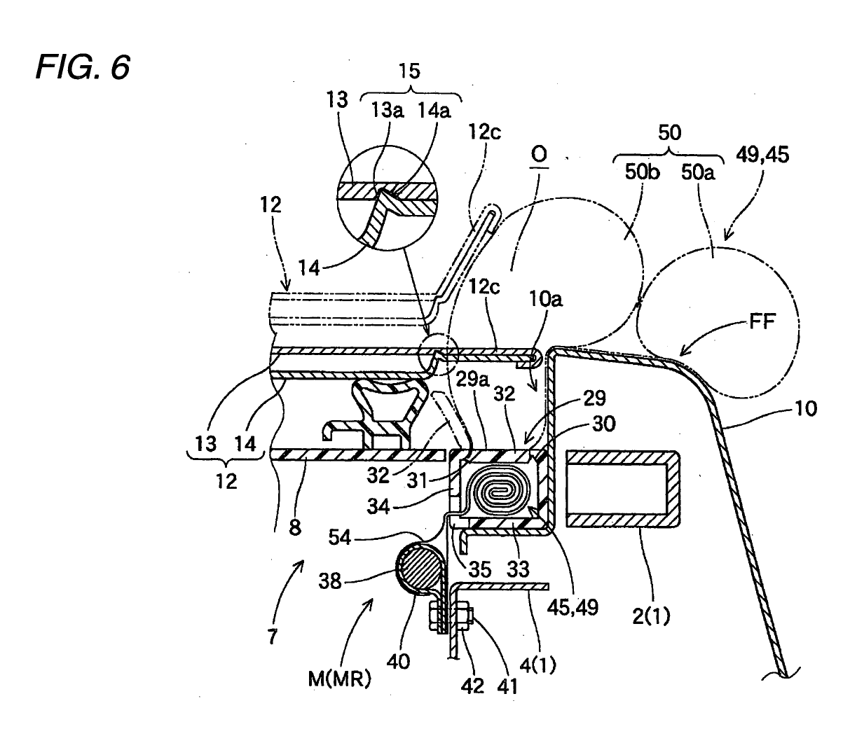

As shown in FIGS. 2 and 6, the front fenders FF are provided with hood ridge reinforces 2, which are members of a vehicle body 1, in the longitudinal direction, and front fender panels 10 formed of sheet metals are disposed so as to cover the hood ridge reinforces 2 from the above. The front fender panels 10 are provided so as to be flush with a surface of the hood panel 12 adjacent thereto.

The hood panel 12 is provided so as to cover an engine room 7 of the vehicle V from the above, and connected to the body 1 of the vehicle V by means of hinge parts 17, at a position near a back end thereof at both side edges in the lateral direction so as to be opened and closed from a front side. The hood panel 12 in this embodiment includes an outer panel 13 provided at a surface side, and an inner panel 14 provided at a back face side having higher rigidity than the outer panel 13, both of which are formed of aluminum (or aluminum alloy).

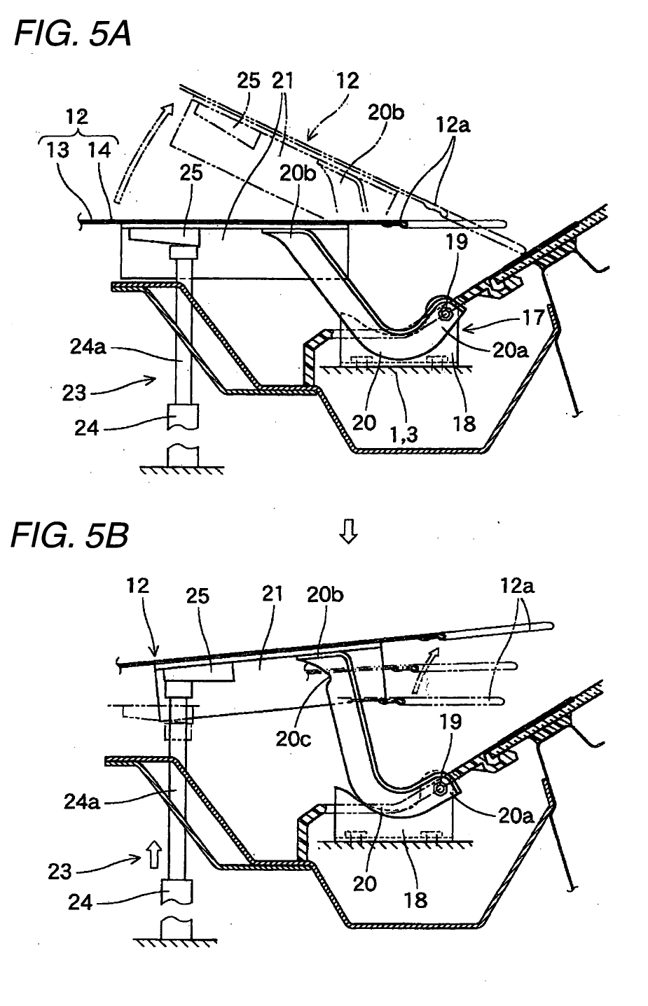

The hinge parts 17 are provided on the edges (the end edges) 12b, 12c of the hood panel 12 in the lateral direction, in vicinity of the back end 12a. Each of the hinge parts 17 includes a hinge base 18 fixed to a mounting flange 3 of the body 1, a mounting bracket 21 connected to the hood panel 12, and a hinge arm 20 connected to the hinge base 18 and the mounting bracket 21 (See FIG. 5). As shown in FIG. 5, the hinge arm 20 is designed as an angled member formed of sheet metal which is curved in a substantially semicircular shape projecting downward. A base end 20a of the hinge arm 20 is connected to the hinge base 18 by means of a support shaft 19 so as to rotate with respect to the hinge base 18, and a distal end 20b remote from the base end 20a is fixed to the mounting bracket 21 by welding or the like. The support shafts 19 are arranged having their axes extending along the lateral direction of the vehicle V. Therefore, on occasion of opening the hood panel 12, as shown by a two-dot chain line from a solid line in FIG. 5A, the front end of the hood panel 12 is lifted upward so as to be opened from the front side by rotating it around the right and left support shafts 19 together with the distal ends 20b of the respective hinge arms 20 (See FIGS. 4 and 5A).

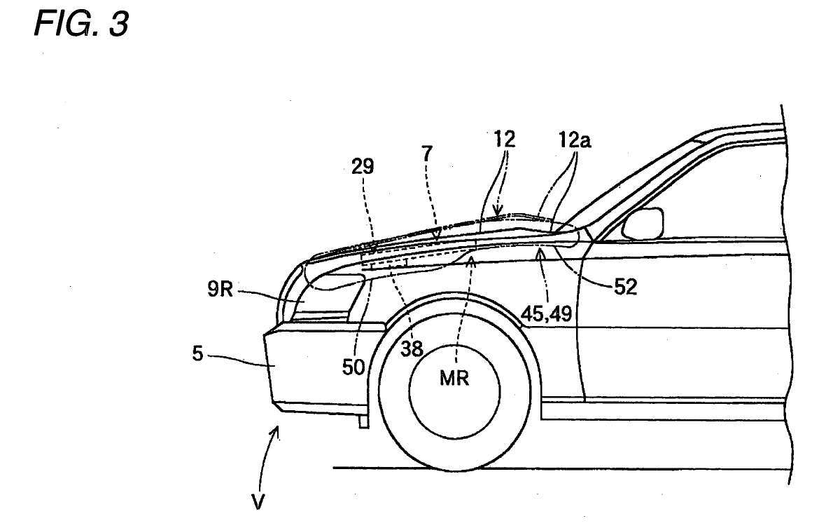

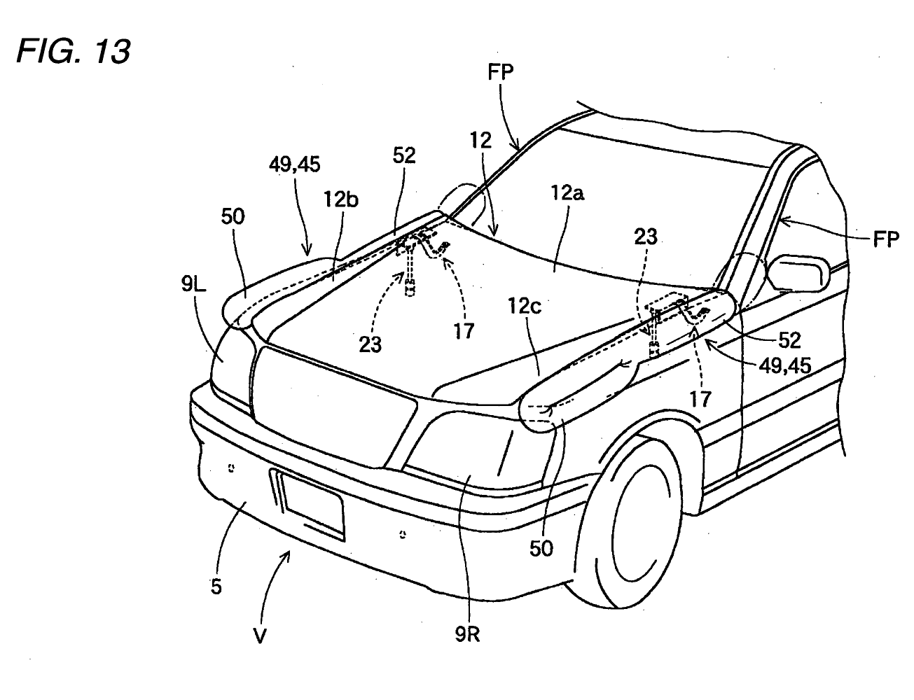

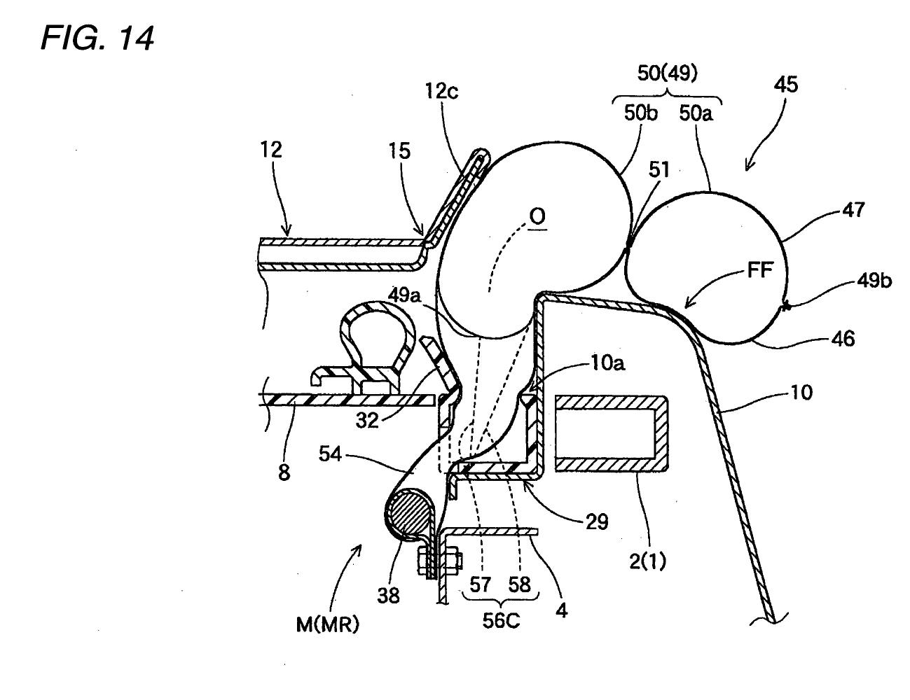

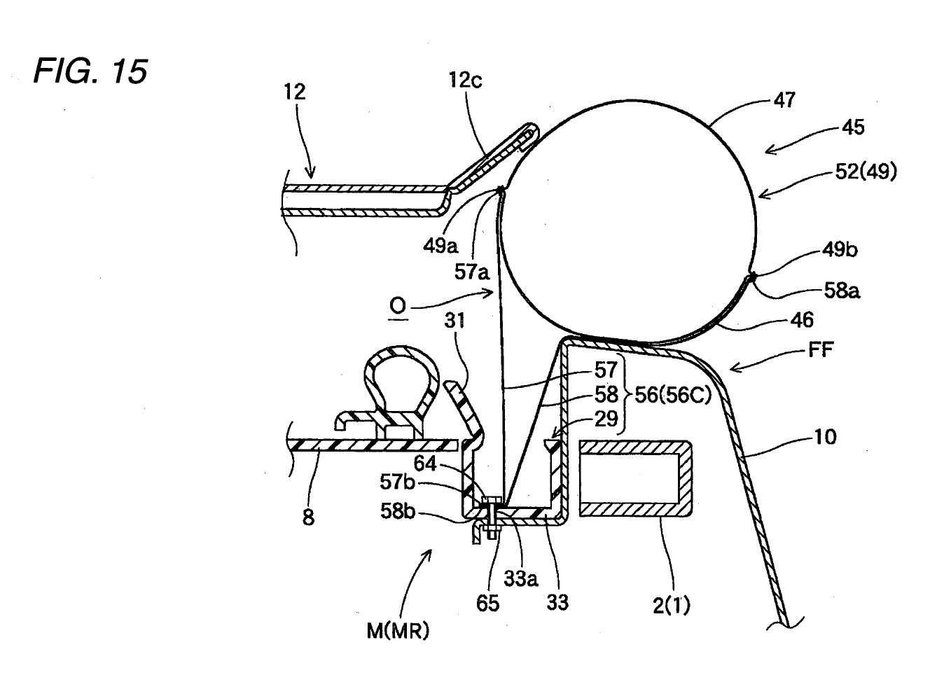

When the vehicle V collides with the pedestrian, the lifting units 23 lift the back end 12a of the hood panel 12 diagonally backward, as shown by two-dot chain lines in FIGS. 1 and 3 and in FIG. 13. In this embodiment, the lifting units 23 are provided for the purpose of lifting the back end 12a of the hood panel 12 to form gaps O between the both edges 12b, 12c in the lateral direction of the hood panel 12 and the front fender panel 10 (See FIGS. 14, 15), and for the purpose of protruding air bags 45 of the air bag systems M, which will be described below, from these gaps O. Specifically, the lifting units 23 respectively include the actuators 24 which are arranged near the right and left hinge parts 17 of the hood panel 12. Each of the actuators 24 includes a push up rod 24a whose axis extends in the vertical direction and incorporates a micro gas generator therein. When the actuator 24 is operated, the push up rod 24a is instantaneously moved upward by combustion gas which is generated by the micro gas generator. The actuator 24 is arranged below the mounting bracket 21 to which the distal end 20b of the hinge arm 20 is connected, and the push up rod 24a is butted against a receiving seat 25 which is provided on a lower face at a front end side of the mounting bracket 21. The push up rod 24a is simply butted against the receiving seat 25 but not fixed thereto, and when the hood panel 12 is opened from the front side by rotating around the supporting shafts 19 of the hinge parts 17, the push up rod 24a is detached from the receiving seat 25 which moves upward (See the two-dot chain line in FIG. 5A).

When the actuators 24 are actuated to move the push up rods 24a upward, the back end 12a of the hood panel 12 is rotated in a backward and upward direction around the supporting shafts 19 at the side of the base ends 20a of the hinge arms 20, at a rotation radius equal to a length in the longitudinal direction from the base end 20a to the distal end 20b of the hinge arm 20, while the distal ends 20b of the hinge arms 20 are moved upward. On this occasion, regions of the distal ends 20b of the hinge arms 20 to be connected to the mounting brackets 21 of the hood panel 12 are plastically deformed as plastically deformed parts 20c (See FIG. 5B). For this reason, when the lifting units 23 are operated, the hood panel 12 is brought into a state where the back end 12a is lifted in a diagonally upward and backward direction.

Moreover, in the pedestrian protecting systems S in this embodiment, plastically deformed parts 15 are formed in the hood panel 12 near the right and left edges 12b, 12c. The plastically deformed parts 15 are formed such that when the air bags 45 in the air bag systems M are spread and inflated, the right and left edges 12b, 12c are respectively pushed by body parts 49 of the air bags 45 which are being inflated upward, as will be described below, and can be plastically deformed so as to direct their respective edge sides in the lateral direction to the above. Specifically, as shown in FIG. 2, these plastically deformed parts 15 are formed in the hood panel 12 along the longitudinal direction over substantially entire regions in the longitudinal direction above inner edges of the air bag systems ML, MR (inner walls 34 of cases 29 which will be described below). More specifically, describing referring to the edge 12c of the hood panel 12 at the right side as an example, the plastically deformed part 15 is composed of a thin-walled part 13a which is formed by partially cutting away a lower face of the outer panel 13, and a fold 14a which is formed by folding the inner panel 14 itself at a corresponding position of the inner panel 14 (See FIG. 6). This plastically deformed part 15 is formed for the purpose of smoothly protruding the air bag 45 from the gap O which is formed between the edge 12b, 12c in the lateral direction of the hood panel 12 and the front fender panel 10, when the air bag 45 is spread and inflated.

In this embodiment, the air bag systems M are respectively provided at two positions of the right and left edge sides of the hood panel 12. The air bag system MR is arranged below the right side edge 12c of the hood panel 12 near the front fender FF, and the air bag system ML is arranged below the left side edge 12b of the hood panel 12 near the front fender FF (See FIGS. 2 to 5). Because these air bag systems MR, ML are formed of the same members which are symmetrical in the lateral direction, the air bag system MR which is arranged at the right side will be described as an example in this embodiment, and description of the air bag system ML which is arranged at the left side will be omitted. As shown in FIG. 6, the air bag system M (MR) includes the air bag 45, the single inflator 38 for supplying inflating gas to the air bag 45, and the case 29 as a containing part for containing the air bag 45 which has been folded.

The case 29 is disposed in a dented part 10a which is formed in the front fender panel 10 in a manner recessed at a side close to the engine room 7, and constructed in a substantially elongated shape extending along the longitudinal direction, from a position near a head lamp 9R which is positioned at a front end side of the front fender FF to a substantially center in the longitudinal direction of the hood panel 12 (See FIGS. 3 to 5). In this embodiment, the case 29 is formed of a member called as a fender protector in an ordinary vehicle. The fender protector is the member which is provided in the dented part 10a in the front fender panel 10 to be in flush with a surface of an engine room cover 8 which is provided so as to cover components in the engine room such as an engine, which are not shown, for the purpose of improving an inner appearance of the engine room 7. In this embodiment, this fender protector is utilized as the case 29 which is the containing part for containing the air bag 45.

The case 29 is formed of synthetic resin including olefin type thermoplastic resin such as polypropylene (PP), and thermoplastic elastomer such as olefin type thermoplastic elastomer (TPO), and formed in a shape of an elongated box so as to cover an entire circumference of the air bag 45 which has been folded, in the vertical, longitudinal and lateral directions, while an upper face 29a is flush with the surface of the engine room cover 8, as shown in FIG. 6. An upper wall part of the case 29 covering the folded air bag 45 from the above has a hinge part 31 at an inner edge opposed to the hood panel 12, and remaining three walls (three walls including front and back edges, and an outer edge) of the case 29 are provided with fracture expected parts 30. When the air bag 45 is spread and inflated, the fracture expected parts 30 are broken, and the upper wall part is formed as a door part 32 which is rotated around the hinge part 31 to be opened toward the hood panel 12. Moreover, in the air bag system M in this embodiment, only the folded air bag 45 is contained in the case 29, and the inflator 38 for supplying the inflating gas to the air bag 45 is disposed below the case 29. Further, an insertion hole 35 through which a flow inlet 54 of the air bag 45, which will be described below, can be inserted is formed near a front end of the case 29 in a region from an inner edge of a bottom wall 33 covering a lower part of the folded air bag 45 to a lower edge of an inner wall 34 covering the folded air bag 45 at a side opposed to the hood panel 12. This insertion hole 35 is set to have such a size that the flow inlet 54 which has been inflated can pass, when the air bag 45 has been completely inflated. As shown in FIG. 15, the bottom wall 33 of the case 29 is further provided with a through hole 33a capable of passing a bolt 64 for securing a strap 56 of the air bag 45, which will be described below, to the front fender panel 10. In this embodiment, the strap 56 of the air bag 45 is secured to the front fender panel 10 through the bottom wall 33. Specifically, the through hole 33a is formed near an inner edge of the bottom wall 33 at the side opposed to the hood panel 12.

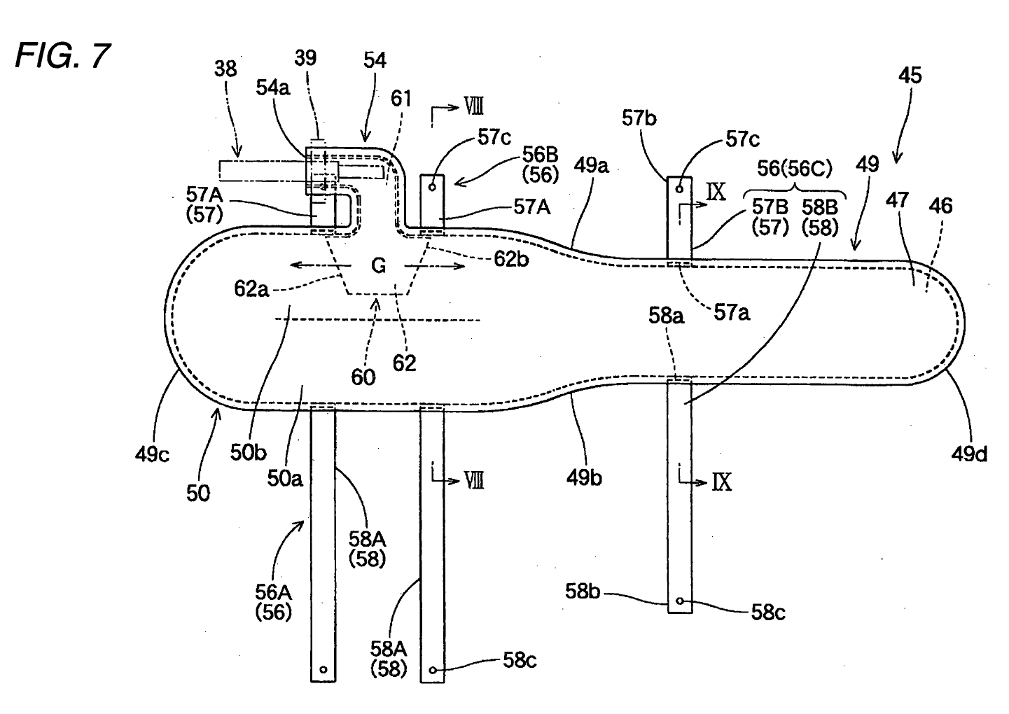

As described above, the inflator 38 in a substantially columnar shape having a gas discharge port, which is not shown, is disposed at only one position near and below the front end of the case 29, so that its axis may extend along the longitudinal direction, as shown in FIG. 6. The inflator 38 is connected to the flow inlet 54 of the air bag 45 by means of a clamp 39 (See FIG. 7) for enabling the inflating gas to flow into the air bag 45, and at the same time, held by a bracket 40 formed of sheet metal, as shown in FIG. 6. This bracket 40 is fixed to a mounting bracket 4 extending from a front body of the body 1, which is not shown, by means of a bolt 41 and a nut 42.

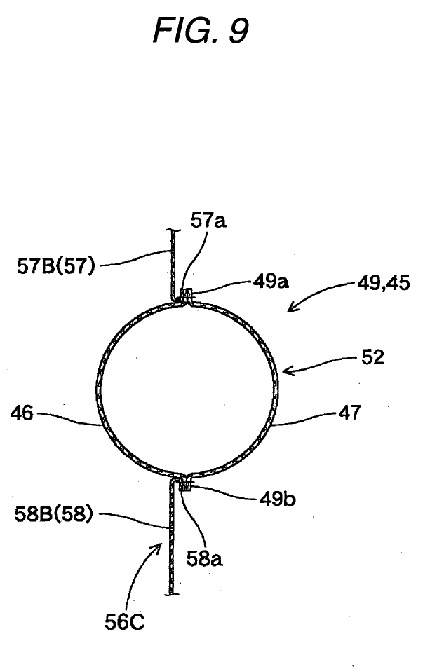

The air bag 45 is adapted to be inflated when the inflating gas which has been discharged from the inflator 38 flows into the air bag 45. In this embodiment, as shown in FIGS. 7 to 10, the air bag 45 is in a shape of a bag formed of woven cloth employing polyester threads or polyamide threads. In this embodiment, the air bag 45 is a flat faced bag which is composed of a base cloth for constituting a vehicle side wall 46 to be arranged at a side of the vehicle V (a lower face side), when the air bag has been completely inflated, and a base cloth for constituting a pedestrian side wall 47 to be arranged at a side of the pedestrian (an upper face side), when the air bag has been completely inflated, both having substantially the same outer shape, by fastening their circumferential edges to each other by sewing. Further, the air bag 45 has a body part 49 which is arranged so as to cover the front fender FF from the above when the air bag has been completely inflated, and the flow inlet 54 which is connected to the inflator 38 for allowing the inflating gas from the inflator 38 to flow into the body part 49.

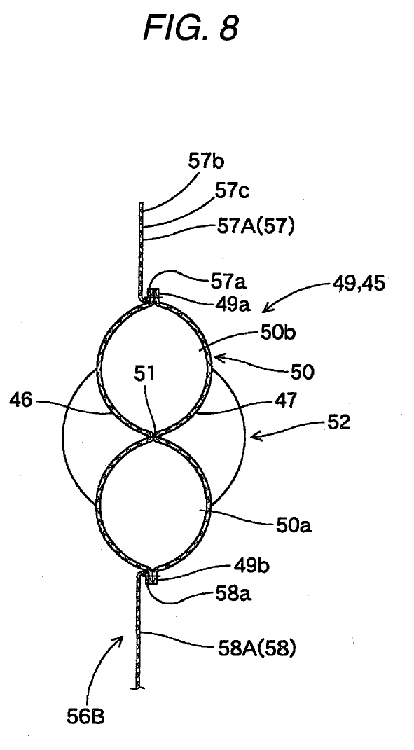

When the air bag 45 has been completely inflated, the body part 49 has an elongated shape along the longitudinal direction, having its length in the longitudinal direction larger than a longitudinal length of the case 29 so that the body part 49 can cover the substantially entire area of the front fender FF including an upper face of a headlamp 9 (9L, 9R) which is provided in front of the front fender. The body part 49 is provided with a partition 51 along the longitudinal direction in a frontward region 50 which is forward from a center of the body part 49 in the longitudinal direction, substantially at a center in the lateral direction, when the air bag has been completely inflated (See FIGS. 7 and 8). This partition 51 partitions the frontward region 50 in the lateral direction. In this embodiment, the partition 51 is formed continuously along the longitudinal direction by fastening the vehicle side wall 46 and the pedestrian side wall 47 to each other by sewing, while its front end is separated backward from a front end 49c of the body part 49, so that a distance between the vehicle side wall 46 and the pedestrian side wall 47 may be narrowed.

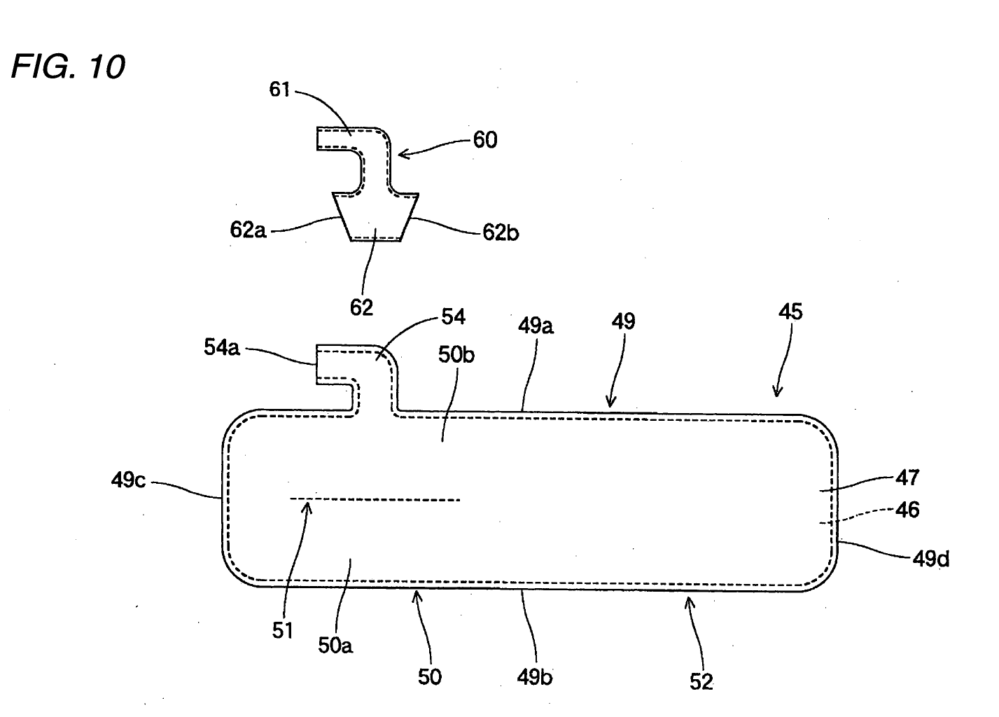

In this embodiment, the body part 49 has a substantially, rectangular shape having a constant width in the lateral direction, in a flat spread state, as shown in FIG. 10. However, the partition 51 is provided only in the frontward region 50, but not provided in a backward region 52 which is backward from the center of the body part 49 in the longitudinal direction. Specifically, in the air bag 45 in this embodiment, the frontward region 50 is partitioned by the partition 51 whereby two cells 50a and 50b in a columnar shape substantially along the longitudinal direction are arranged in parallel in the lateral direction, in the completely inflated state. On the other hand, the backward region 52 has a shape of one column having an outer diameter substantially double of each of the cells 50a, 50b of the frontward region 50, in the completely inflated state. Accordingly, when the air bag 45 has been completely inflated, the frontward region 50 is smaller in thickness but larger in width in the lateral direction, as compared with the backward region 52 in which the partition is not provided (See FIGS. 7 to 9). Moreover, in this embodiment, the inflation of the body part 49 of the air bag 45 will be completed in a state where a part of the cell 50b in the frontward region 50 which is positioned inside the vehicle may not protrude from the gap O (See FIG. 14).

The flow inlet 54 is provided only at the front side of the body part 49 forward from the center in the longitudinal direction. Specifically, in this embodiment, the flow inlet 54 is provided only at one position in the frontward region 50 of the body part 49. More specifically, the flow inlet 54 is formed in an area where the partition 51 is provided in the frontward region 50, so as to project from an inner edge 49a which is positioned at a side close to the hood panel 12 in the completely inflated state. The flow inlet 54 is bent so that its distal end may be directed forward, and the distal end (front end) is opened so that the inflator 38 can be inserted into the flow inlet 54. As shown in FIG. 7, an opening 54a at this distal end of the flow inlet 54 is fitted over the inflator 38, and connected to the inflator 38 by means of the clamp 39.

In this embodiment, the air bag 45 is mounted and fixed to the body 1 of the vehicle V by means of the flow inlet 54 connected to the inflator 38 and the straps 56. In this embodiment, the three straps 56 are provided in parallel in the longitudinal direction, as shown in FIG. 7. The two straps 56A and 56B which are provided at the front end side are provided so as to be positioned in front of and in the back of the flow inlet 54 in the frontward region 50. Specifically, the strap 56A is arranged near a front side of the flow inlet 54 and at a position separated backward from the front end 49c of the body part 49, while the strap 56B is arranged near a back side of the flow inlet 54. The other strap 56C is arranged at a substantially center of the backward region 52 in the longitudinal direction so as to be separated forward from a back end 49d of the body part 49.

As shown in FIG. 7, each of the straps 56 (56A, 56B, 56C) includes an inner member 57 extending from the inner edge 49a of the body part 49 and an outer member 58 extending from an outer edge 49b of the body part 49 which is opposed to the inner edge 49a in the lateral direction. Both the inner member 57 and the outer member 58 are separate bodies from the body part 49 and formed of cloth in a shape of a strap having elasticity. Their base parts 57a, 58a are respectively fastened by sewing to the inner edge 49a and the outer edge 49b. Moreover, insertion holes 57c, 58c through which the bolts 64 (See FIG. 15) can be inserted are respectively formed at distal ends 57b, 58b of the inner member 57 and the outer member 58. In this embodiment, the strap 56 is spread in a flat shape so that the inner member 57 extends from the inner edge 49a and the outer member 58 is positioned at a side close to the vehicle side wall 46, and the distal ends 57b, 58b of the inner member 57 and the outer member 58 are overlapped on each other. Then, the bolt 64 which is inserted into the insertion holes 57c, 58c is projected from the front fender panel 10 through the through hole 33a which is formed in the bottom wall 33 of the case 29 and secured with a nut 65, whereby the air bag 45 is coupled to the case 29 (the body 1 of the vehicle V) (See FIG. 15). Each of the straps 56 is provided such that the inner member 57 and the outer member 58 extend substantially in the lateral direction along an outer peripheral-face of the air bag 45, when the inflation has been completed. In this embodiment, the straps 56A and 56C which are arranged at the front end side and at the back end side are respectively connected to the case 29 near its ends in the longitudinal direction.

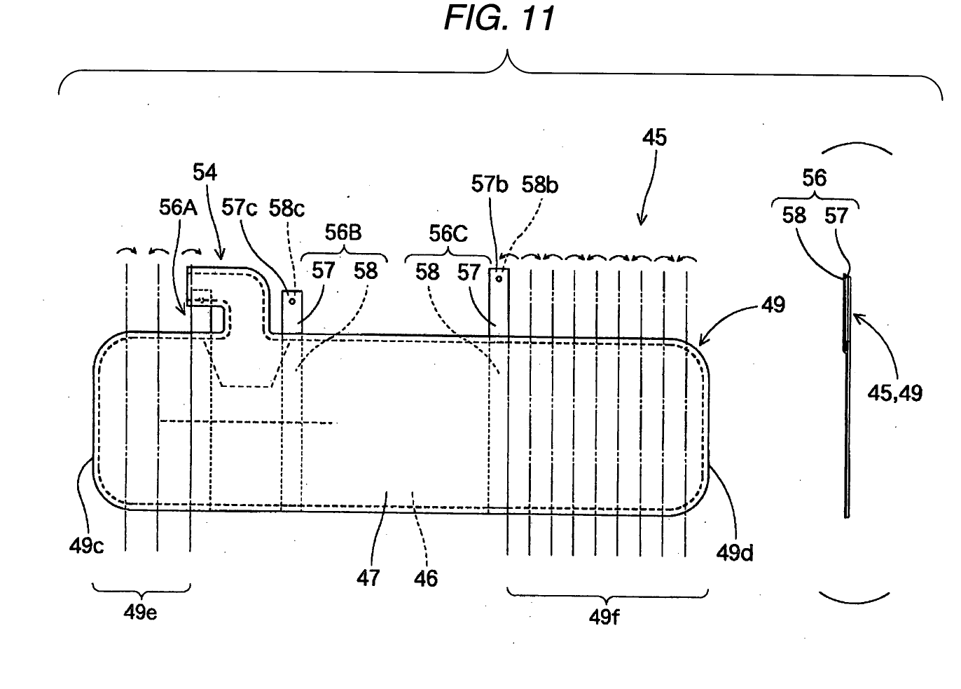

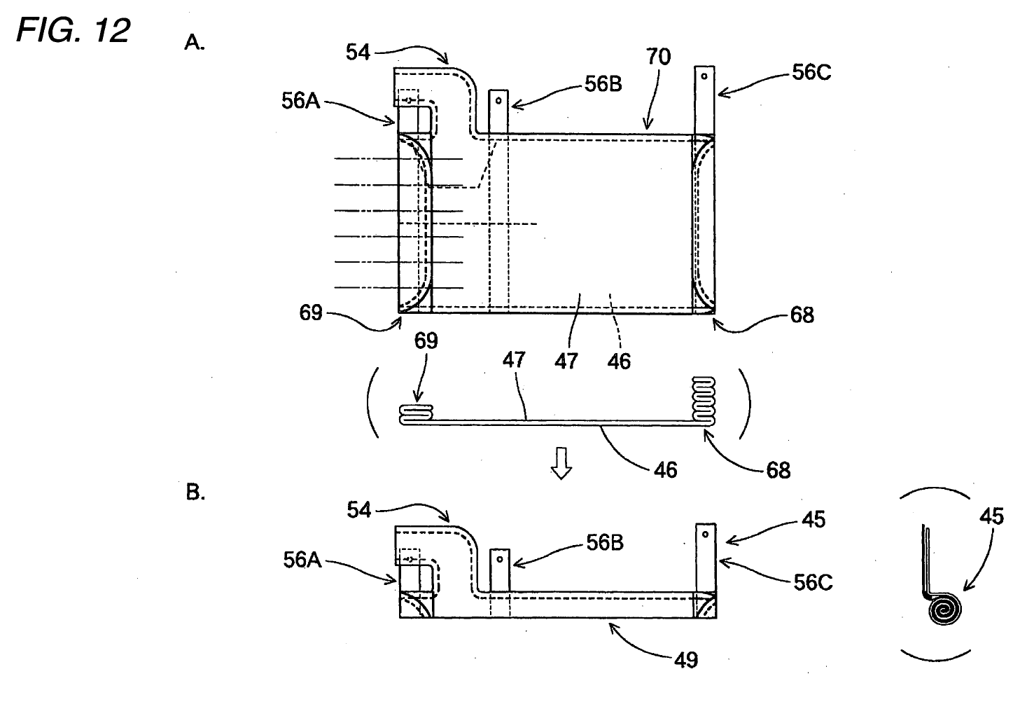

The inner members 57 and the outer members 58 of the straps 56 pull the inner edge 49a and the outer edge 49b of the body part 49 of the air bag 45 in the completely inflated state, toward the bottom wall 33 of the case 29, thereby to prevent the body part 49 from floating up from the front fender FF, when the air bag 45 has been completely inflated. Specifically, the outer members 58 which are provided at the outer edge 49b are set to be larger in length than the inner members 57 which are provided at the inner edge 49a. More specifically, in this embodiment, the frontward region 50 of the body part 49 in the completely inflated state is arranged in a state where a part of the cell 50b positioned inside the vehicle is not protruded from the gap O. Therefore, a distance between the inner edge 49a of the frontward region 50 in the completely inflated state and the bottom wall 33 is smaller than a distance between the inner edge 49a of the backward region 52 in the completely inflated state and the bottom wall 33. Moreover, the frontward region 50 and the backward region 52 are different from each other in width in the lateral direction, as described above, and therefore, the distance between the outer edge 49b of the frontward region 50 in the completely inflated state and the bottom wall 33 becomes larger than the distance between the outer edge 49b of the backward region 52 in the completely inflated state and the bottom wall 33. For this reason, in this embodiment, the lengths of the inner members 57 and the outer members 58 have different lengths between the straps 56A, 56B which are arranged in the frontward region 50 and the strap 56C which is arranged in the backward region 52. The inner members 57A of the straps 56A, 56B which are arranged in the frontward region 50 are set to be smaller in length than the inner member 57B of the strap 56C which is arranged in the backward region 52, while the outer members 58A of the straps 56A, 56B which are arranged in the frontward region 50 are set to be larger in length than the outer member 58B of the strap 56C which is arranged in the backward region 52. Further, in the straps 56 (56A, 56B, 56C), in a state where the outer members 58 (58A, 58B) are overlapped on the vehicle side wall 46 of the body part 49 which has been spread flat (that is, when the air bag 45 is folded), the lengths of the inner members 57 (57A, 57B) and the outer members 58 (58A, 58B) are set such that positions of the distal ends 57b, 58b and the insertion holes 57c, 58c may be the same (See FIGS. 11, 12). The inner members 57 and the outer members 58 are fixed to the bottom wall 33 of the case 29 by means of the bolts 64, in a state where determined brackets formed of sheet metal are interposed.

Moreover, as shown in FIG. 7, a rectifying cloth 60 for rectifying the inflating gas which has been discharged from the inflator 38 is provided inside the body part 49. The rectifying cloth 60 is a separate body from the air bag 45, and formed of woven cloth employing polyester threads, polyamide threads or the like, in the same manner as the air bag 45. As shown in FIG. 10, the rectifying cloth 60 includes a fitting part 61 to be arranged in the flow inlet 54 and a rectifying part 62 to be arranged in the body part 49. The rectifying part 62 which is in a substantially cylindrical shape having a larger width in the longitudinal direction than the fitting part 61 (the flow inlet 54) and opens at both end sides in the longitudinal direction is communicated with the fitting part 61 at a substantially center position in the longitudinal direction. Specifically, the rectifying part 62 has flow outlets 62a, 62b through which the inflating gas can flow out toward the front end 49c and the back end 49d of the body part 49, at positions in front and in the back of the flow inlet 54.

The air bag 45 in this embodiment is folded, as described below, and contained in the case 29. In this embodiment, the air bag 45 is folded laterally by forming folds along the lateral direction to reduce the length of the body part 49 in the longitudinal direction, and then, folded longitudinally by forming folds along the longitudinal direction to reduce the width of the body part 49 in the lateral direction. Specifically, as shown in FIG. 11, the body part 49 is spread flat, as a first step, such that the vehicle side wall 46 and the pedestrian side wall 47 are overlapped, and the outer members 58 of the straps 56 are superposed on the vehicle side wall 46. Then, a frontward area 49e of the body part 49 positioned in front of the strap 56A and a backward area 49f positioned in the back of the strap 56C are respectively accordion-folded by forming folds along the lateral direction so that the front end 49c and the back end 49d may approach to the center, whereby the air bag is laterally folded so as to be reduced in length in the longitudinal direction into an allowable size to be contained in the case. 29 (See FIG. 11 and FIG. 12A). On this occasion, a front folded part 67 which is formed by folding the frontward area 49e and a back folded part 68 which is formed by folding the backward area 49f are respectively placed on the pedestrian side wall 47 of the body part 49, as shown in FIG. 12A. Thereafter, as shown in FIG. 12B, a laterally folded body part 70 is rolled to be wound toward the vehicle side wall 46, while an outer edge 70b is made close to an inner edge 70a by forming folds along the longitudinal direction, and the body part 49 is longitudinally folded so as to be reduced in width in the lateral direction into an allowable size to be contained in the case 29. In this manner, the air bag 45 can be folded.

In this embodiment, the front folded part 67 which is formed by folding the frontward area 49e positioned in front of the strap 56A in the frontward region 50 is folded such that the folds can be released more quickly than in the back folded part 68 which is formed by folding the backward area 49f positioned in the back of the strap 56C in the backward part 52, when the air bag 45 is spread and inflated. Such releasing speed of the folds of the air bag 45 can be set by adjusting the number of the folds and folding widths. Specifically, in this embodiment, the front folded part 67 is folded such that the folding width is larger and the number of the folds is smaller than the back folded part 68 (See FIG. 11 and FIG. 12A).

In the air bag system M in this embodiment, the air bag 45 which has been folded as described above is wrapped with a breakable wrapping member for preventing collapse, which is not shown. On this occasion, the flow inlet 54, and the distal ends 57b, 58b of the inner members 57 and the outer members 58 of the straps 56 are projected from the wrapping member. Moreover, the bolts 64 are inserted into the insertion holes 57c, 58c which are formed in the distal ends 57b, 58b of the inner members 57 and the outer members 58 of the straps 56. Thereafter, the folded air bag 45 is contained in the case 29 having the flow inlet 54 protruded from the insertion hole 35 and having the bolts 64 protruded from the through holes 33a. Then, the inflator 38 is connected to the flow inlet 54 of the air bag 45 which is protruded from the case 29 by means of the clamp 39, and the bracket 40 is fitted to the inflator 38. In this manner, the air bag assembly can be formed.

Then, the case 29 is placed in the dented part 10a of the front fender panel 10, the nut 65 is fastened to the bolt 64 which has been projected from the front fender panel 10, and the bracket 40 of the inflator 38 is fixed to the fitting bracket 4 extending from the body 1 by means of the bolt 41 and the nut 42. In this manner, the air bag system M can be mounted on the vehicle M.

In the pedestrian protecting device S provided with the air bag system M in this embodiment and mounted on the vehicle, when the sensor 6 provided on the front bumper 5 detects collision against the pedestrian, and an actuating signal is inputted to the actuator 24 of the lifting unit 23 and the inflator 38 of the air bag system M, the actuator 24 is operated to push the push up rod 24a, whereby the back end 12a of the hood panel 12 is pushed up, and the gap O is formed. At the same time, the air bag 45 is spread and inflated by the inflating gas which is discharged from the inflator 38 and flows into the air bag. Then, the air bag 45 plastically deforms the edges 12b, 12c of the hood panel 12 while pushing the door part 32 of the case 29 to open, and protrudes from the gap O, whereby the air bag 45 will be completely inflated so as to cover the front panel FF from the above (See the two-dot chain lines in FIGS. 1 to 3, 6 and FIGS. 13 to 15).

In the air bag system M in this embodiment, the flow inlet 54 for allowing the inflating gas to flow from the inflator 38 into the body part 49 of the air bag 45 is provided only at the position forward from the center in the longitudinal direction of the body part 49 in the completely inflated state. Specifically, in this embodiment, because the flow inlet 54 is provided only in the frontward region 50 of the body part 49, the inflating gas G (See FIG. 7) flows into the body part 49 of the air bag 45 firstly from the frontward region 50 forward from the center in the longitudinal direction where the flow inlet 54 is arranged, when the inflator 38 is operated, thereby to inflate the air bag 45. For this reason, in the air bag system M in this embodiment, the frontward region 50 of the air bag 45 can be inflated more quickly as compared with the backward region 52 in an initial period of the inflation, in spite of its elongated shape in the longitudinal direction in the completely inflated state. As the results, it is possible to prevent a head of the short pedestrian from striking a part of the vehicle near the front fender FF.

Accordingly, in the air bag system M in this embodiment, the frontward region 50 of the air bag 45 can be quickly inflated, and the short pedestrian can be reliably protected.

In the air bag system M in this embodiment, the inflator 38 is provided only at the one position forward from the center in the longitudinal direction of the body part 49 of the air bag 45 in the completely inflated state, and therefore, it is of course possible to decrease the number of components, as compared with the conventional pedestrian air bag system, and hence, production steps and cost can be reduced.

Moreover, in the air bag system M in this embodiment, the air bag 45 which has been folded so as to reduce the length of the body part 49 both in the longitudinal and lateral directions from the flat spread state, and contained in the case 29. On occasion of folding and containing the air bag, the air bag 45 is folded and contained in the case 29 such that the folds can be released more quickly in the part of the body part 49 positioned forward from the flow inlet 54 than in the part positioned backward from the flow inlet 54. Specifically, in this embodiment, in the body part 49 in the flat spread state in which the vehicle side wall 46 and the pedestrian side wall 47 are overlapped, when laterally folded, the part positioned forward from the flow inlet 54 (the frontward area 49e positioned in front of the strap 56A) and the part positioned backward from the flow inlet 54 (the backward area 49f positioned in the back of the strap 56C) are accordion-folded by forming the folds along the lateral direction. At the same time, the front folded part 67 which is formed by folding the part positioned in front of the flow inlet 54 (the frontward area 49e positioned in front of the strap 56A) is formed by accordion folding, having the larger folding width and the smaller folding number than the back folded part 68 which is formed by folding the part positioned in the back of the flow inlet 54 (the backward area 49f positioned in the back of the strap 56C) (See FIGS. 11 and 12A). Accordingly, in the air bag system M in this embodiment, the folds can be more quickly released in the front folded part 67 than in the back folded part 68 at the initial period of the inflation of the air bag 45. As the results, the frontward region 50 is spread while the folds are released more quickly than in the backward region 52, and it is possible to inflate the frontward region 50 of the air bag 45 further quickly.

Moreover, in this embodiment, the body part 49 is folded by accordion-folding, from the flat spread state in which the vehicle side wall 46 and the pedestrian side wall 47 are overlapped, so as to reduce the length in the longitudinal direction by forming the front folded part 67 and the back folded part 68. The folded shapes of the front folded part and the back folded part are not limited to those in the embodiment. For example, it is possible to form the front folded part and the back folded part in an ordinary folding manner which is employed in folding the air bag, such as roll folding, a manner of folding for reducing the width by inserting a part of a peripheral wall (so-called cactus folding), etc. When these three folding manners are compared, the cactus folding is most quickly released, and the accordion folding is next, while the roll folding is released most slowly. Considering performances of these folding manners, it is possible to fold the front folded part by the cactus folding or the accordion folding which can be released quickly, for example, and to fold the back folded part by the roll folding. Of course, it is possible to fold both the front folded part and the back folded part in the same folding manner, as in this embodiment. For example, in case where both the front folded part and the back folded part are folded by the roll folding, the front folded part may be rolled loosely, as compared with the back folded part, so that the folds can be more quickly released. Moreover, in case where both the front folded part and the back folded part are folded by the cactus folding, the front folded part may be folded with the smaller folding width and the more folding steps than the back folded part so that the folds can be released more quickly than in the back folded part. It is to be noted that the cactus folding can be employed only in case where the air bag is folded through the longitudinal folding in which the folds are formed along the longitudinal direction, after the lateral folding in which the folds are formed along the lateral direction has been performed from the flat spread state as in the embodiment. In case where the air bag is folded by forming the front folded part and the back folded part, by conducting the lateral folding after the longitudinal folding, the front folded part and the back folded part can be formed only by the accordion folding or roll folding.

In the air bag system M in this embodiment, the body part 49 of the air bag 45 is longitudinally folded so as to reduce the width in the lateral direction, after it has been laterally folded so as to reduce the length in the longitudinal direction, and then contained in the case 29. Accordingly, the body part 49 has been first widely spread in the lateral direction while protruding from the case 29 at the initial period of the inflation, and thereafter, the body part 49 will be inflated while spreading widely in the longitudinal direction. In other words, the body part 49 protrudes from the case 29 in a state not widely spread in the longitudinal direction at the initial period of the inflation. Therefore, the body part 49 of the air bag 45 is restrained from protruding from the front end side of the hood panel 12 where a pushing amount by the lifting unit 23 is small, but can be smoothly protruded from a position near the center of the hood panel 12 in the longitudinal direction where the relatively large distance can be secured between the edges 12b, 12c and the front fender panel 10. As the results, the body part 49 spreads widely in the longitudinal direction after it has been protruded from the gap O, and it is possible to quickly complete the inflation of the body part 49. Of course, in case where this point is not taken into consideration, it is possible to fold the air bag 45 by laterally folding so as to reduce the length in the longitudinal direction, after it has been longitudinally folded so as to reduce the width in the lateral direction, to the contrary to the folding order in the embodiment.

In the air bag system M in this embodiment, the rectifying cloth 60 is arranged in the air bag 45, and this rectifying cloth 60 is provided with the flow outlets 62a, 62b for allowing the inflating gas to flow out toward the front end 49c and the back end 49d of the body part 49, respectively at positions in front and in the back of the flow inlet 54. Therefore, in the air bag system M in this embodiment, the inflating gas G which is discharged from the inflator 38 and flows into the body part 49 from the flow inlet 54 is rectified by the rectifying cloth 60, and flows from the flow inlet 54 toward the front end 49c and the back end 49d (See the two-dot chain line in FIG. 7). As the results, the body part 49 of the air bag 45 can be quickly and widely spread in the longitudinal direction, and the backward region 52 can be also inflated at the utmost speed, while the quick inflation of the frontward region 50 is secured. Of course, the rectifying cloth may not be provided in the air bag, in case where this point is not taken into consideration.

Further, in the air bag system M in this embodiment, the body part 49 of the air bag 45 is provided with the partition 51 which is arranged in the frontward region 50 substantially in the longitudinal direction so as to narrow the distance between the vehicle side wall 46 and the pedestrian side wall. 47 which are opposed in the vertical direction in the completely inflated state, and so as to connect the vehicle side wall 46 and the pedestrian side wall 47 to each other and to partition the frontward region 50 in the lateral direction. Accordingly, the frontward region 50 in the completely inflated state has such a shape that its size is smaller in thickness and larger in width in the lateral direction as compared with the backward region 52 where the partition is not provided (See FIGS. 14, 15). For this reason, in the air bag system M in this embodiment, it is possible to cover the laterally large area of the front side of the front fender FF from the above with the frontward region 50 of the inflated air bag 45. As the results, when the air bag has been completely inflated, it is possible to cover the front fender FF from the above widely in the lateral direction, including the upper face of the headlamp 9R (9L) which is provided in the surrounding, and it is possible to stably receive the head of the short pedestrian by the frontward region 50 which has been completely inflated, even though the head of the short pedestrian is somewhat displaced in the lateral direction.

In the embodiment, the partition 51 is formed by fastening the vehicle side wall 46 and the pedestrian side wall 47 to each other by sewing. However, the shape of the partition is not limited to the shape in the embodiment, but it is possible to connect the vehicle side wall 46 and the pedestrian side wall 47, by using, as the partition, a tether in a strap shape in a manner of reducing the distance between the vehicle side wall 46 and the pedestrian side wall 47. Moreover, although the partition 51 is formed continuously along the longitudinal direction in the embodiment, it is apparent that the partition may be provided intermittently. In case where such function is not taken into consideration, it is, of course, possible to use the air bag in which the partition is not provided in the frontward region.

Still further, in the air bag system M in this embodiment, the body part 49 of the air bag 45 is connected to the case 29 as the containing part, by means of the straps 56A, 56B, 56C which are provided at the three positions in parallel along the longitudinal direction in the completely inflated state (See FIG. 15), and the two straps 56A, 56B which are positioned at the front end side are provided in front and in the back of the flow inlet 54 (See FIG. 7). In short, in the air bag system M in this embodiment, both the front and back sides of the flow inlet 54 of the air bag 45 are connected to the case 29 by means of the straps 56A, 56B. Therefore, it is possible to prevent both the front and back sides of the flow inlet 54 from being remarkably displaced up and down and to the right and left, at the initial period of the inflation of the air bag 45. Moreover, in the air bag system M in this embodiment, because the straps 56A, 56B, 56C are provided at the three positions of the body part 49 along the longitudinal direction in the completely inflated state, it is possible to prevent the body part 49 of the air bag 45 from being inflated in a manner of floating from the front fender FF over substantially the entire areas along the longitudinal direction, when the body part 49 is spread and developed. Therefore, the body part 49 of the air bag 45 which has been inflated can quickly cover the front fender FF from the above. Although the straps 56 are provided at the three positions in the embodiment, the straps may not be provided on the air bag in case where the above described point is not taken into consideration.

Still further, in the air bag system M in this embodiment, each of the straps includes the inner member 57 extending from the inner edge 49a of the body part 49 in the completely inflated state and the outer member 58 extending from the outer edge 49b which is opposed to the inner edge 49a in the lateral direction, as shown in FIGS. 7 and 15, and the distal ends 57b, 58b are fastened together to the case 29 at the side close to the hood panel 12. Accordingly, it is possible not only to restrain the body part 49 of the air bag 45 from being displaced up and down, and to the right and left, but also to prevent the body part 49 from being twisted in the lateral direction while it is spread and inflated. As the results, it is possible to inflate the body part 49 of the air bag 45 so as to stably and quickly cover the front fender FF from the above. Of course, it is possible to provide the strap at either one of the inner edge and the outer edge, in case where this point is not taken into consideration.

In the pedestrian protecting system S provided with the air bag system M in this embodiment, the back end 12a of the hood panel 12 is lifted by means of the lifting units 23, whereby the gaps O for protruding the air bags 45 therethrough are respectively formed between the edge 12b, 12c of the hood panel 12 in the lateral direction and the front fender panel 10. Naturally, each of the gaps O is formed such that the opening width in the vertical direction is the largest at the side of the back end 12a of the hood panel 12, and is reduced toward the front end. However, in the pedestrian protecting system S in this embodiment, the hood panel 12 is provided with the plastically deformed parts 15 which enable the edges 12b, 12c of the hood panel 12 in the lateral direction to be plastically deformed upwardly, when the edges 12c, 12c are pushed up by the body parts 49 of the air bags 45 which are inflated upward, when the air bags 45 are spread and developed. As the results, even at the position in the front end side of the hood panel 12 where the amount to be pushed up by the lifting units 23 is small, it is possible to smoothly protrude the air bags 45 from the gaps O which are formed between the edges 12b, 12c in the lateral direction of the hood panel 12 which have been plastically deformed. Particularly, in the air bag systems M in this embodiment, because the inflating gas discharged from the inflators 38 first flows into the frontward regions 50 of the body parts 49 through the flow inlets 54, it is possible, with the frontward regions 50 which are inflated, to remarkably push up the frontward area of the hood panel 12 near the edges 12b, 12c in the lateral direction with the larger amount of plastic deformation, and to quickly protrude the frontward regions 50 from the gaps O. Although in this embodiment, the plastically deformed parts 15 are formed over the substantially entire areas in the longitudinal direction of the hood panel 12, actually, the hood panel 12 is not plastically deformed in the areas near the back end 12a where the gaps O can be sufficiently secured between the edges 12b, 12c in the lateral direction of the hood panel 12 which have been pushed up by the lifting units 23.

Still further, in the pedestrian protecting system S in this embodiment, the back end 12a of the hood panel 12 is lifted by the lifting units 23. Therefore, in case where the pedestrian who has bumped against the vehicle V interferes with the upper face of the hood panel 12, the hood panel 12 is plastically deformed to absorb motion energy of the pedestrian, and the pedestrian is prevented from striking hard components such as the engine which are arranged in the engine room 7 below the hood panel 12. As the results, it is also possible to protect the pedestrian at the position of the hood panel 12. Moreover, in this embodiment, because the plastically deformed parts 15 are provided near the edges 12b, 12c in the lateral direction of the hood panel 12 so as to plastically deform the edges 12b, 12c by pushing the end edges upward, the structure without the lifting units 23 is also allowable.

Still further, in this embodiment, the respective air bag systems M which constitute the pedestrian protecting systems S in cooperation with the hood panel 12 and the lifting units 23 are provided below the edges 12b, 12c in the lateral direction of the hood panel 12, and adapted to protrude the air bags 45 from the gaps O which are formed when the hood panel 12 is lifted. However, the positions where the air bag systems are provided are not limited to this arrangement. For example, it is possible to contain the air bag systems in containing parts which are formed by denting the surfaces of the front fender panels at positions laterally separated from the hood panel. In case where the air bag systems are provided at such positions, the hood panel need not be lifted up, and hence, it is possible to mount the air bag systems on a vehicle which is not provided with the lifting units for lifting the hood panel.

Still further, in the air bag system M in this embodiment, the air bag 45 which has been inflated covers only the front fender FF from the above. However, as shown by the two-dot chain line in FIG. 13, it is possible to use such an air bag as covering a lower end area of a front pillar FP which is arranged in the back of the front fender FF, when the air bag has been completely inflated.

What is claimed is:

1. A pedestrian air bag system comprising:
an air bag which folded and contained in a containing part near a front fender arranged at an end edge in a lateral direction of a hood panel disposed at a front end side of a vehicle to cover above an engine room, and
an inflator which is connected to said air bag for enabling inflating gas to be supplied to the air bag,
said air bag being so constructed as to cover a substantially entire area in a longitudinal direction of said front fender, when the inflating gas has flowed into said air bag,
wherein said air bag includes a body part which is inflated to cover above said front fender, and a flow inlet connected to said inflator for allowing the inflating gas to flow from said inflator to said body part, and that said flow inlet is provided only at a position forward from a center in the longitudinal direction of said body part when the air bag has been completely inflated.

2. An air bag system as claimed in claim 1, wherein said body part of the air bag is folded so as to reduce its widths in the longitudinal direction and in the lateral direction from a flat spread state, and at the same time, said body part is folded such that in an initial period of the inflation, folds may be released more quickly in a region positioned forward from said flow inlet than in a region positioned backward from said flow inlet, and contained in said containing part.

3. An air bag system as claimed in claim 1, wherein a rectifying cloth for rectifying the inflating gas which has been discharged from said inflator is provided inside said air bag, and
said rectifying cloth is provided with flow outlets for allowing said inflating gas to flow out toward opposite ends of said body part, respectively at a position forward from said flow inlet and at a position backward from said flow inlet.

4. An air bag system as claimed in claim 1, wherein said body part of the air bag is provided with a partition which is arranged substantially along the longitudinal direction in a frontward region thereof which is positioned forward from the center in the longitudinal direction in the completely inflated state, so that when the air bag has been completely inflated, a distance between upper and lower walls of said body part which are opposed to each other in a vertical direction may be narrowed, and said frontward region may be partitioned in the lateral direction, by connecting the upper and lower walls to each other.

5. An air bag system as claimed in claim 1, wherein said body part of the air bag is connected to said containing part by straps provided at three or more positions in the longitudinal direction of said body part in the completely inflated state, wherein
two of said straps provided at a front end side are arranged at opposite sides forward and backward from said flow inlet.

6. An air bag system as claimed in claim 5, wherein each of said straps includes an inner member extending from an inner edge of said body part at a side close to said hood panel in the completely inflated state, and an outer member extending from an outer edge opposed to said inner edge in the lateral direction, and opposite distal ends of said inner member and said outer member are fastened together to said containing part at a position close to said hood panel.
